(19) United States
(12) Patent Application Publication
(10) Pub. No.: US 2024/0013792 A1
(43) Pub. Date: Jan. 11, 2024

(54) AUDIO COMPRESSION METHOD FOR IMPROVING COMPRESSION RATIO

(71) Applicant: Mstream Technologies., Inc., New Taipei City (TW)

(72) Inventor: CHING-HSIANG LEE, New Taipei City (TW)

(21) Appl. No.: 17/861,120

(22) Filed: Jul. 8, 2022

(51) Int. Cl. G10L 19/005; G10L 25/21; G10L 19/00; G10L 19/04

(52) U.S. Cl. CPC G10L 19/005; G10L 25/21; G10L 19/0017; G10L 19/04

(57) ABSTRACT

An audio compression method for improving a compression ratio is provided. The audio compression method includes steps of: obtaining a plurality of audio values of audio data of an audio frame that are generated before next audio data is generated, as a plurality of reference audio values; predicting an audio value of the next audio data as a predicted audio value, according to the plurality of reference audio values; calculating a difference between the predicted audio value and an actual audio value corresponding thereto, as a first audio error value; and compressing the first audio error value.

### FIELD OF THE DISCLOSURE

The present disclosure relates to an audio compression method, and more particularly to an audio compression method for improving a compression ratio.

### BACKGROUND OF THE DISCLOSURE

Numerous data compression techniques have been devised to compress files such as to facilitate efficient storage management and data transmission over communication lines. Data compression techniques have long been used for speeding up data transfer, by reducing the amount of space taken up by information being sent.

### SUMMARY OF THE DISCLOSURE

In response to the above-referenced technical inadequacies, the present disclosure provides an audio compression method for improving a compression ratio. The audio compression method includes the following steps: obtaining an audio frame including an audio signal having a plurality of waveforms; selecting one of multiple pieces of audio data of the audio frame as next audio data; obtaining a plurality of audio values of the audio data of the audio frame that are generated before the next audio data is generated, as a plurality of reference audio values; predicting an audio value of the next audio data as a predicted audio value, according to the plurality of reference audio values; obtaining the audio value of the next audio data, as an actual audio value; calculating a difference between the predicted audio value and the actual audio value corresponding thereto, as a first audio error value; and compressing the first audio error value.

### BRIEF DESCRIPTION OF THE DRAWINGS

The described embodiments may be better understood by reference to the following description and the accompanying drawings, in which:

FIG. 1 is a flowchart diagram of an audio compression method according to a first embodiment of the present disclosure;

FIG. 2 is a flowchart diagram of an audio compression method according to a second embodiment of the present disclosure;

FIG. 3 is a flowchart diagram of an audio compression method according to a third embodiment of the present disclosure;

FIG. 4 is a flowchart diagram of an audio compression method according to a fourth embodiment of the present disclosure;

FIG. 5 is a flowchart diagram of an audio compression method according to a fifth embodiment of the present disclosure;

FIG. 6 is a flowchart diagram of an audio compression method according to a sixth embodiment of the present disclosure; and

FIG. 7 is a block diagram of an audio compression system according to the first to sixth embodiments of the present disclosure.

### DETAILED DESCRIPTION OF THE EXEMPLARY EMBODIMENTS

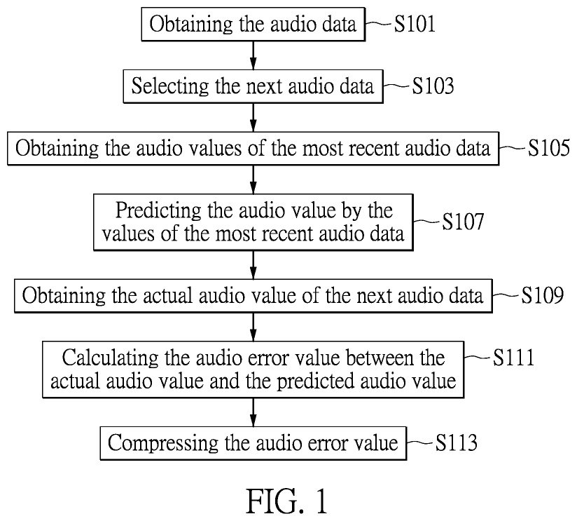

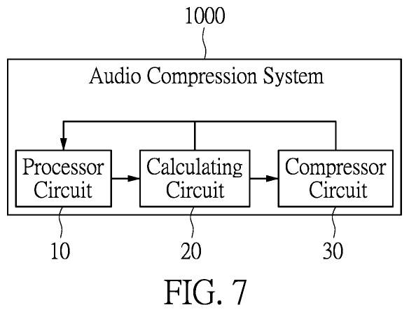

Reference is made to FIGS. 1 and 7, in which FIG. 1 is a flowchart diagram of an audio compression method according to a first embodiment of the present disclosure, and FIG. 7 is a block diagram of an audio compression system according to the first to sixth embodiments of the present disclosure.

The audio compression method may include steps S101 to S113 as shown in FIG. 1. Steps S101 to S113 may be performed by an audio compression system 1000 including a processor circuit 10, a calculating circuit 20 and a compressor circuit 30 as shown in FIG. 7. The calculating circuit 20 is connected to the processor circuit 10 and the compressor circuit 30.

In step S101, the processor circuit 10 obtains audio data of an audio frame including an audio signal having a plurality of waveforms.

In step S103, the processor circuit 10 selects one of multiple pieces of audio data of the audio frame as next audio data.

In step S105, the processor circuit 10 obtains a plurality of audio values of the audio data that are generated before the next audio data is generated, as a plurality of reference audio values.

In step S107, the processor circuit 10 predicts an audio value of the next audio data as a predicted audio value according to the plurality of reference audio values.

In step S109, the processor circuit 10 obtains the audio value of the next audio data, as an actual audio value. The processor circuit 10 outputs the actual audio value to the calculating circuit 20.

In step S111, the calculating circuit 20 calculates a difference between predicted audio value and the actual audio value corresponding thereto, as a first audio error value. The calculating circuit 20 outputs the first audio error value to the compressor circuit 30.

In step S113, the compressor circuit 30 compresses the first audio error value.

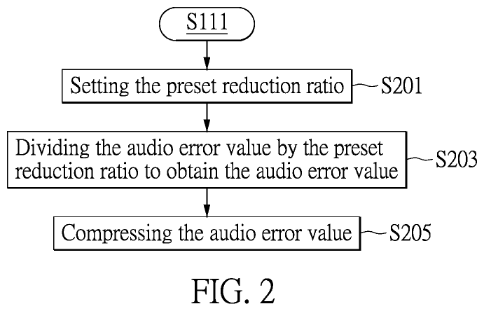

Reference is made to FIGS. 2 and 7, in which FIG. 2 is a flowchart diagram of an audio compression method according to a second embodiment of the present disclosure.

The audio compression method may further include steps S201 to S205 as shown in FIG. 2. After the first audio error value is calculated in step S111 as described above, steps S201 to S205 may be sequentially performed by the audio compression system 1000 as shown in FIG. 7.

In step S201, the processor circuit 10 sets a preset reduction ratio according to (audio values, energy or a data length of) the audio data, and outputs the preset reduction ratio to the calculating circuit 20.

In step S203, the calculating circuit 20 divides the first audio error value by the preset reduction ratio to obtain a second audio error value. The second audio error value is smaller than the first audio error value.

In step S205, the compressor circuit 30 compresses the second audio error value from the calculating circuit 20.

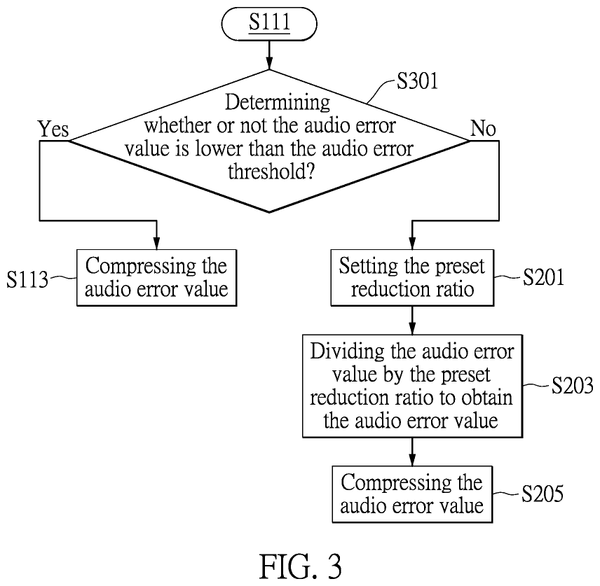

Reference is made to FIGS. 3 and 7, in which FIG. 3 is a flowchart diagram of an audio compression method according to a third embodiment of the present disclosure. The audio compression method may further include a step S301 as shown in FIG. 3.

After the first audio error value is calculated in step S111, step S301 and then step S113 or steps S201 to S205 may be performed by the audio compression system 1000 as shown in FIG. 7.

In step S301, the processor circuit 10 determines whether or not the first audio error value is lower than an audio error threshold. If the processor circuit 10 determines that the first audio error value is lower than the audio error threshold, the compressor circuit 30 compresses the first audio error value in step S113 as described above.

Conversely, if the processor circuit 10 determines that the first audio error value is not lower than the audio error threshold, the compressor circuit 30 compresses the second audio error value in steps S201 to S205 as described above.

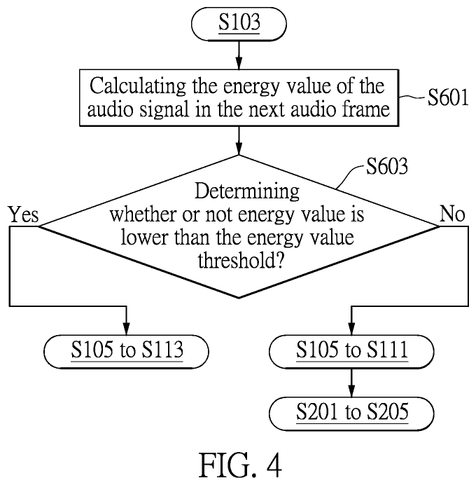

Reference is made to FIGS. 4 and 7, in which FIG. 4 is a flowchart diagram of an audio compression method according to a fourth embodiment of the present disclosure.

The audio compression method may further include steps S601 to S603 as shown in FIG. 4. After step S103 is performed as described above, steps S601 to S603 may be performed by the audio compression system 1000.

In step S601, the calculating circuit 20 calculates an energy value of the audio signal in the audio frame as a first energy value.

In step S603, the processor circuit 10 determines whether or not the first energy value is lower than the energy value threshold. If the processor circuit 10 determines that the first energy value is lower than the energy value threshold, steps S105 to S113 are sequentially performed as described above. In step S113, the compressor circuit 30 compresses the first audio error value.

Conversely, steps S105 to S111 and steps S201 to S205 are sequentially performed as described above. In step S205, the compressor circuit 30 compresses the second audio error value.

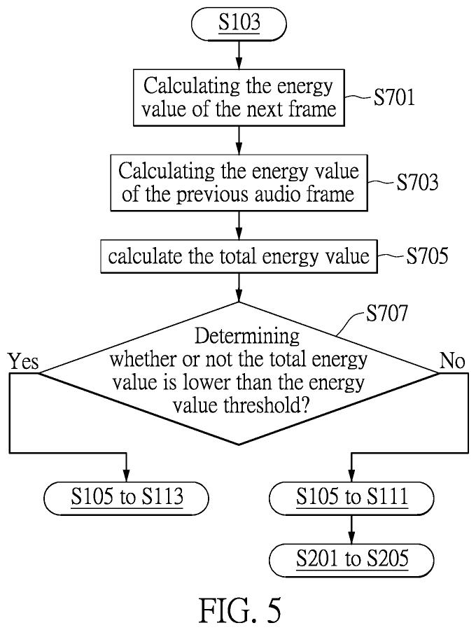

Reference is made to FIGS. 5 and 7, in which FIG. 5 is a flowchart diagram of an audio compression method according to a fifth embodiment of the present disclosure.

The audio compression method may further include steps S701 to S707 that may be performed by the audio compression system 1000 after step S103 is performed.

In step S701, the calculating circuit 20 calculates a first energy value of the audio signal in the audio frame.

In step S703, the calculating circuit 20 calculates a second energy value of the audio signal of the audio data in at least parts of the previous audio frame.

In step S705, the calculating circuit 20 adds up the first energy value and the second energy value to obtain a total energy value.

In step S707, the calculating circuit 20 determines whether or not the total energy value is lower than the energy value threshold. If the calculating circuit 20 determines that the total energy value is lower than the energy value threshold, steps S105 to S113 are sequentially performed as described above. In step S113, the compressor circuit 30 compresses the first audio error value.

Conversely, steps S105 to S113 and steps S201 to S205 are sequentially performed as described above. In step S205, the compressor circuit 30 compresses the second audio error value.

The first energy value described herein may be calculated as follows. The calculating circuit 20 calculates a squared value of an amplitude of each of the plurality of waveforms of the audio signal in the audio frame. Then, the calculating circuit 20 adds up the squared values of the plurality of waveforms of the audio signal to obtain a total energy value. Then, the calculating circuit 20 divides the first energy value by a number of the plurality of waveforms of the audio signal in the audio frame to obtain an energy average value. Finally, the calculating circuit 20 calculates a logarithm of the energy average value to obtain the first energy value of the audio frame. The second energy value may also be calculated in a similar manner.

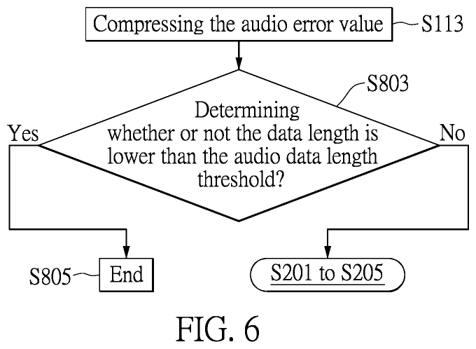

Reference is made to FIGS. 6 and 7, in which FIG. 6 is a flowchart diagram of an audio compression method according to a sixth embodiment of the present disclosure.

The audio compression method may further include steps S803 to S805 as shown in FIG. 6. After the compressor circuit 30 compresses the first audio error value of the audio frame to generate original audio compressed data (via lossless compression) in step S113, the steps S803 and then S805 or S201 to S205 may be performed.

In step S803, the processor circuit 10 determines whether or not a data length of the original audio compressed data of the first audio error value is lower than an audio data length threshold.

If the processor circuit 10 determines that the data length of the original audio compressed data of the first audio error value is not lower than the audio data length threshold, steps S201 to S205 may be performed. In step S205, the compressor circuit 30 compresses the second audio error value that is equal to the first audio error value divided by the preset reduction ratio. Conversely, any step is not then performed.

Alternatively, the compressor circuit 30 compresses the audio data of the audio frame to generate original audio compressed data. If the processor circuit 10 determines that the data length of the original audio compressed data of the audio data is not lower than the audio data length threshold, the compressor circuit 30 compresses the first audio error value or the second audio error value.

In conclusion, the present disclosure provides the audio compression method for improving the compression ratio. The first audio error value between the predicted audio value and the actual audio value, or the second audio error value that is equal to the first audio error value divided by preset reduction ratio, can be compressed by the audio compression method of the present disclosure. Therefore, the data length of the compressed data can be reduced, thereby improving the compression ratio of compressing the audio data.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An audio compression method for improving a compression ratio, comprising the following steps:
obtaining an audio frame including an audio signal having a plurality of waveforms;
selecting one of multiple pieces of audio data of the audio frame as next audio data;
obtaining a plurality of audio values of the audio data of the audio frame that are generated before the next audio data is generated, as a plurality of reference audio values;
predicting an audio value of the next audio data as a predicted audio value, according to the plurality of reference audio values;
obtaining the audio value of the next audio data, as an actual audio value;
calculating a difference between the predicted audio value and the actual audio value corresponding thereto, as a first audio error value; and
compressing the first audio error value.

2. The audio compression method according to claim 1, further comprising the following steps:
dividing the first audio error value by a preset reduction ratio to obtain a second audio error value being smaller than the first audio error value; and
compressing the second audio error value.

3. The audio compression method according to claim 1, further comprising the following steps:
determining whether or not the first audio error value is lower than an audio error threshold, in response to determining that the first audio error value is lower than the audio error threshold, compressing the first audio error value and not performing next steps, and in response to determining that the first audio error value is not lower than the audio error threshold, performing next steps;
dividing the first audio error value by a preset reduction ratio to obtain a second audio error value being smaller than the first audio error value; and
compressing the second audio error value.

4. The audio compression method according to claim 1, further comprising the following steps:
calculating a first energy value of the audio signal in the audio frame; and
determining whether or not the first energy value is lower than an energy value threshold, in response to determining that the first energy value is lower than the energy value threshold, compressing the first audio error value, and in response to determining that the first energy value is not lower than the energy value threshold, compressing the second audio error value.

5. The audio compression method according to claim 4, further comprising the following steps:
calculating a squared value of an amplitude of each of the plurality of waveforms of the audio signal in the audio frame;
adding up the squared values of the plurality of waveforms of the audio signal in the audio frame to obtain a total energy value; and
dividing the total energy value by a number of the plurality of waveforms of the audio signal in the audio frame to obtain an energy average value; and
calculating a logarithm of the energy average value as the first energy value of the audio signal in the audio frame.

6. The audio compression method according to claim 1, further comprising the following steps:
calculating a first energy value of the audio signal in the audio frame;
determining whether or not the first energy value is lower than an energy value threshold, in response to determining that the first energy value is lower than the energy value threshold, compressing the first audio error value and not performing next steps, and in response to determining that the first energy value is not lower than the energy value threshold, performing next steps;
dividing each of the first audio error value by a preset reduction ratio to obtain a second audio error value being smaller than the first audio error value; and
compressing the second audio error value via the lossless compression.

7. The audio compression method according to claim 6, further comprising the following steps:
calculating a squared value of an amplitude of each of the plurality of waveforms of the audio signal in the audio frame;
adding up the squared values of the plurality of waveforms of the audio signal in the audio frame to obtain a total energy value;
dividing the first energy value by a number of the plurality of waveforms of the audio signal in the audio frame to obtain an energy average value; and
calculating a logarithm of the energy average value to obtain the first energy value of the audio frame.

8. The audio compression method according to claim 1, further comprising the following steps:
calculating a first energy value of the audio signal in the audio frame;
calculating a second energy value of the audio signal of the audio data in at least parts of the previous one of the plurality of audio frame;
adding up the first energy value and the second energy value to obtain a total energy value; and
determining whether or not the total energy value is lower than an energy value threshold, in response to determining that the total energy value is lower than the energy value threshold, compressing the first audio error value of the audio frame, and in response to determining that the total energy value is not lower than the energy value threshold, compressing second audio error value that is equal to the first audio error value divided by a preset reduction ratio, wherein the second audio error value is smaller than the first audio error value.

9. The audio compression method according to claim 1, further comprising the following steps:
compressing the audio data of the audio frame to generate original audio compressed data via lossless compression; and
determining whether or not a data length of the original audio compressed data is lower than an audio data length threshold, in response to determining that the data length of the original audio compressed data is lower than the audio data length threshold, retaining the original audio compressed data, and in response to determining that the data length of the original audio compressed data is not lower than the audio data length threshold, compressing the first audio error value of the audio frame via the lossless compression.

10. The audio compression method according to claim 1, further comprising the following steps:
compressing the first audio error value of the audio frame to generate original audio compressed data via lossless compression;
determining whether or not a data length of the original audio compressed data is lower than an audio data length threshold, in response to determining that the data length of the original audio compressed data is lower than the audio data length threshold, retaining the original audio compressed data and not performing next steps, and in response to determining that the data length of the original audio compressed data is not lower than the audio data length threshold, performing next steps;
dividing the first audio error value by a preset reduction ratio to obtain a second audio error value being smaller than the first audio error value; and
compressing the second audio error value of the audio frame.
